(19) United States
(12) Patent Application Publication
(10) Pub. No.: US 2014/0019754 A1
(43) Pub. Date: Jan. 16, 2014

(54) ANONYMOUS AND UNLINKABLE DISTRIBUTED COMMUNICATION AND DATA SHARING SYSTEM

(71) Applicants: Olivier Heen, Domloup (FR); Christoph Neumann, Rennes (FR); Stephane Onno, Saint Gregoire (FR); Erwan Le Merrer, Tregastel (FR)

(72) Inventors: Olivier Heen, Domloup (FR); Christoph Neumann, Rennes (FR); Stephane Onno, Saint Gregoire (FR); Erwan Le Merrer, Tregastel (FR)

(73) Assignee: THOMSON LICENSING, Issy de Moulineaux (FR)

(21) Appl. No.: 14/006,099

(22) PCT Filed: Mar. 13, 2012
(86) PCT No.: PCT/EP2012/054372

§ 371 Date: Sep. 18, 2013

(30) Foreign Application Priority Data
Mar. 21, 2011 (EP) 11305314.4

(51) Int. Cl. H04L 9/30; H04L 9/32

(52) U.S. Cl. CPC H04L 9/30; H04L 9/3247
USPC 713/162

(57) ABSTRACT

A distributed communication and data sharing system that provides anonymity and unlinkability. A group comprising a number of structures, each having a public/private key pair, is stored on a plurality of nodes in a Distributed Hash Table. Advantageous features of the group management system are provided through the use of Cryptographically Generated Addresses (CGA) for the structures, a secure capture method that enables a user to capture an address and be the only one authorized to request certain operations for the address, and an anonymous get/set mechanism in which a user signs messages, encloses the public key in the message and encrypts the message and public key using the public key of the receiver. The distributed communication and data sharing system of the invention can advantageously be used for group management of social networks.

### TECHNICAL FIELD

The present invention relates generally to a distributed communication and data sharing system and in particular to the privacy of communication and users in such a system.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Group management systems are used as the underpinning for many kinds of applications: mailing-lists, social networks, transports, trusted device lists, etc. Examples of such group management systems are LinkedIn and Facebook.

A group management system is characterized by its entities and operations:
Entities are users, groups of users and contents. Some users may have privileges like administrator, moderator or group creator.
Operations are for example creating or deleting a user, creating or deleting a group, joining or leaving a group, adding or removing content in or from a group.
Contents may be untyped data or references to data (like URLs) available in a group.

Most group management systems involve a central entity for managing the groups. This entity is responsible for hosting the system, providing users credentials, administrating groups. The use of a central entity has two major inherent drawbacks:
Availability: the central entity is a single point of failure and the load is not distributed over client systems.
Trust: the central entity holds all relevant data and carries all privacy and security relevant operations.

A distributed group management system based on a distributed communication and data sharing system with privacy properties can mitigate these availability and trust issues. A system using a Distributed Hash Table (DHT) may be particularly advantageous.

FIG. 1 illustrates an exemplary group management system implemented on a DHT. An exemplary group 120 comprises a root structure 122, a wall (also called whiteboard) structure 124 for representing content available to group members, an inbox structure 126 for communication within the group, and a list structure 128 representing the users of the group or other groups. The group 120 overlays a DHT 100 having a plurality of nodes 110 (represented by circles) that can be independent. The arrows indicate that the root structure 122 is stored by one node, the wall structure 124 by another and so on. In other words, the content is spread over a plurality of nodes. Through the use of the DHT, there is no need for any central authority as the nodes can provide the necessary features.

One implementation of a DHT is to partition a key space over the participating nodes. When a content item is to be stored, its title (or perhaps the entire item) is hashed to obtain a value that corresponds to a key. The content item is then routed through the nodes (each node having a routing table) to the node that is responsible for the key, and this node stores the content item. To retrieve an item, a request comprising the relevant hash value is sent through the network of participating nodes until it reaches the node responsible for the corresponding key. This node retrieves the item and returns it through the network.

However, while the distributed character of the DHT has some interesting features, it is also exposed to attacks coming from the distributed nodes themselves. Such attacks comprise de-anonymizing users, linking anonymous users, and observing activities of users and groups. Several attacker models are known in this area, for example the “honest but curious” model and the “byzantine” model. Attacks against users anonymity can be an important problem as they can allow more efficient social engineering, more efficient phishing messages that mentions the identity of the receiver (thus seeming more trustworthy), etc.

It will thus be appreciated that there is a need for a distributed communication and data sharing system, which may underlie a distributed group management system, with fair resistance against anonymity and unlinkability attacks from an attacker that controls some nodes.

Anonymity: an attacker cannot use information gathered from controlled nodes for inferring the identity of an entity in the distributed communication and data sharing system.

Unlinkability: an attacker cannot use information gathered from controlled nodes for inferring that two entities in the communication and data sharing system are the same.

An example of an attack, the “group fingerprint” attack, against anonymity and unlinkability has been described by Gilbert Wondracek, Thorsten Holz, Engin Kirda and Christopher Kruegel in “A Practical Attack to De-Anonymize Social Network Users”; Technical Report TR-iSecLab-0110-001.

Sobastien Canard, Eric Malville, and Jacques Traoré provide a solution in “Identity Federation and Privacy: One Step Beyond”, DIM '08, Proceedings of the 4th ACM workshop on Digital identity management, ACM, New York, N.Y., USA, 2008, ISBN: 978-1-60558-294-8. Their solution prevents so-called “linking” attacks, but has the drawback that it requires a central component for authentication.

The skilled person will appreciate that it is known that anonymity and unlinkability can always be broken in specific circumstances, such as:
Insufficient group cardinality issues, e.g. if a group is trivially restrained to a single user. More generally, the so called anonymity set must be sufficient with respect to the context of the application.
Explicit disclosure of an entity's identity, e.g. when a user voluntary reveals the identity behind an entity, or gives uniquely equivalent semantic information.
Explicit disclosure of cryptographic keys, e.g. owing to bad manipulations, loss, key collected from an embedded devices, etc.
Cases where members of a group, and only members of this group, share fixed characteristic information (like a picture); this information can be used as a group equivalent.
Trivial repartition of information (for instance, if all entities share a property, then any entity individually has the property), simple computational dependencies (for instance if the average value (a+b)/2 is known and a is known, then b is inherently known), etc.

The present invention provides a solution with fair resistance against anonymity and unlinkability attacks from an attacker that controls some nodes.

### SUMMARY OF INVENTION

In a first aspect, the invention is directed to a system for distributed communication and data sharing. The system comprises a plurality of nodes, implemented on a plurality of computers, adapted to store and retrieve data. The plurality of nodes make up a distributed hash table having a plurality of addresses, wherein each node corresponds to at least one address of the distributed hash table. The data comprises at least one structure having at least one public/private key pair, and is stored by at least one computer at at least one cryptographically generated address of the distributed hash table, the at least one address being generated from the at least one public key of the structure. Each address is subject to capture by a user having a user private key after which owner operation is performed by the node corresponding to the address only upon reception of a request signed using the user private key of the user that has captured the address and to which end the node stores the corresponding user public key to enable verification of the signature. At least one kind of message sent to a captured address comprises a reply address and is encrypted using the public key of the captured address.

In a first preferred embodiment, the at least one kind of message to the node is signed using a private key of the sender and further comprise a corresponding public key.

In a second preferred embodiment, the reply address is the cryptographically generated address of a public key of the sender.

In a third preferred embodiment, the reply address is any free address of the distributed hash table.

### BRIEF DESCRIPTION OF DRAWINGS

Preferred features of the present invention will now be described, by way of non-limiting example, with reference to the accompanying drawings, in which

FIG. 1 illustrates an exemplary group management system implemented on a Distributed Hash Table (DHT).

### DESCRIPTION OF EMBODIMENTS

A goal of the present invention is to provide a communication and data sharing system that is distributed over a Distributed Hash Table (DHT), that has anonymity and unlinkability properties and that may be used to implement a group management system.

According to the invention, a group is associated with one or more addresses (i.e. keys) of the DHT. Each address of the DHT is managed by one node, usually implemented on some kind of computer. A plurality of groups may share a DHT. A main inventive idea of the present invention is to restrict the information accessible to the nodes in such a way that the basic operations on the groups—creation/deletion of users, groups etc.—are possible while anonymity and unlinkability are preserved against an attacker that controls nodes.

This is possible owing to the association of a number of cryptographic and network solutions used together in an inventive manner:
an anonymous get/set communication channel between users relying on a DHT
a cryptographically generated address (CGA) mechanism for associating stored data to addresses in the DHT, and
a Byzantine Fault Tolerant DHT.

Finally and most importantly, the targeted security and privacy properties are only achieved if these solutions are extended with:
a secure address capture and update mechanism based on signatures for preventing unauthorized operations over addresses.

### Anonymous Get/Set Communication Channel Using a DHT

Users of the system communicate through PUT and GET operations to write and retrieve data. Users of the system never communicate directly, but rather put and get messages at specific addresses in the DHT while keeping the address owner anonymous (i.e. not linked to a pseudonym). This is similar to post-office boxes in the postal system. This helps when providing an anonymous communication channel between the users of the system.

### Cryptographically Generated Address Mechanism

Cryptographically Generated Addresses (CGA) have their origin in Internet Protocol Version 6 (IPv6) where the mechanism is used to bind a public key to an Ipv6 address. The 64 least significant bits of the 128-bit address are obtained by hashing the public key of the owner of the address. The corresponding private key is used to sign messages and it is then possible to authenticate the message without having recourse to a public-key infrastructure.

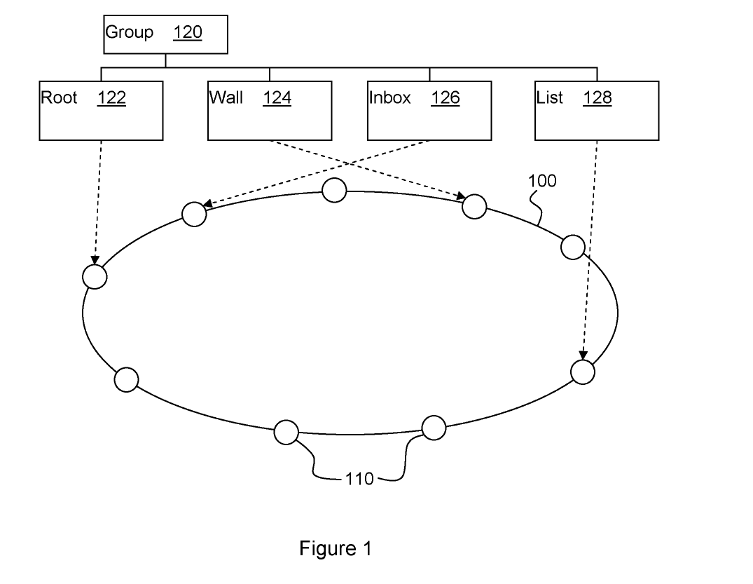

In the present invention, the CGA is preferably calculated using the hash value of the public key to obtain the entire address. Further, while each of the four structures illustrated in FIG. 1—the root structure, the list structure, the wall structure and the inbox structure—may share one CGA space, it is preferred that each structure is associated to one CGA space. Thus, each structure has an asymmetric key pair and its address is, for example, based on the hash of its public key, as described hereinbefore.

### Byzantine Fault Tolerance (BFT)

Byzantine fault tolerance provides a defence against attacks in which a certain number of participating nodes are corrupted. In case of such an attack, the uncorrupted nodes in a Byzantine fault tolerant system are still able to provide the correct service of the system, assuming there are not too many corrupted nodes. It is preferred that the system according to the present invention implements a Byzantine Fault Tolerant DHT such as the one described in “Practical Robust Communication in DHTs Tolerating a Byzantine Adversary,” by M. Young, A. Kate, I. Goldberg, and M. Karsten; ICDCS, 2010.

### Secure Address Capture and Update

According to the invention, each address is associated with one of two possible states: a free state and a captured state.

In a new DHT, all the addresses are free and anyone can capture a free address by picking a public key, calculating its CGA and then performing an operation to capture the address. Operations for capturing a free address comprise: CaptureRoot, CaptureList and CaptureWall. The entity that captures an address is called the owner of the address.

Once an address has been captured, only the owner should be able to perform certain operations for the captured address. This may be enforced by having the owner sign operation requests with the corresponding private key, in which case the node that corresponds to the captured address needs to store, or at least have access to, the owner's public key, since this is needed to verify the signatures on these requests. Examples of operation that are restricted to owners are: UpdateRoot, CloseRoot, WriteList, Readlist, AppendWall, ReadWall, SanitizeWall.

The node that corresponds to the address stores the public key in order to enable verification of signatures on data stored by the node. The verification may be performed by the node itself or by any entity that has retrieved the stored data.

In addition, the node preferably stores a counter value c. The owner also stores the same counter value. When the owner wishes to update the stored data, it increments its counter value and includes the incremented counter value in the update message that is then signed using the private key. Upon reception, the node may first decrypt the update message using the stored public key and then verify that the counter value included in the update message has indeed been incremented. Upon successful verification, the node updates its counter value c and the stored data.

Other operations are not subject to these restrictions and any node can perform these operations. Such operations can comprise WriteInbox, ReadInbox and SanitizeInbox since anyone should be able to send and receive messages. SanitizeInbox is a specific instantiation of WriteInbox. The latter operations require knowledge of the Inbox address.

Finally, it is possible to free a captured address using the FreeAddress procedure:
either by proving the possession of the private key associated with the captured address, or
by an explicit request of the installed software (e.g. through a software version update which is applied on the system nodes).

It will be appreciated that the use of a Byzantine Fault Tolerant DHT ensures that all nodes of the DHT comply with the “secure address capture and update mechanism”; if the DHT is not BFT, one corrupted node can arbitrarily alter the data associated to a captured address under its responsibility.

In the group management system, a group can receive messages like for instance join or leave requests. In the group management system according to a preferred embodiment of the present invention, such messages are sent using a set/get message system in the Inbox structure. Anyone who knows the public key of the Inbox can use the key to encrypt a message that is then sent to the Inbox whose address is the hash of the public key. The owner of the address, who has knowledge of the corresponding private key, may then decrypt and process the message.

The message sent to the Inbox comprises a reply address. This address is preferably the Inbox of the sender, but in an alternate embodiment the reply address changes with each message for any free address on the DHT.

In addition, in a preferred embodiment, the message is signed using a private key of the sender, and the corresponding public key is appended to the signed message.

There are various types of messages that can be sent in the group management system such as for example (in the sense of a typing system):
Root: Message sent to update/capture an address with a root structure
List: Message sent to update/capture an address with a list structure
Join: Message sent to an Inbox to request joining a group
Hello: Message sent to an Inbox after a successfully joining a group
Wall: Message sent to update/capture an address with a wall structure
Leave: Message sent to an Inbox to request leaving a group

The first three types of messages are essential for the present invention. The remaining ones are optional. The system may be extended with other message types.

Table 1 illustrates the structures and their cryptographic keys:

TABLE 1
the cryptographic keys associated to structures

| | | | Private | |
|---|---|---|---|---|
| Structure | Public key | CGA | (signing) key | Encryption key |
| Root | K_{R} | h(K_{R}) | K_{R}⁻¹ | None |
| List | K_{L} | h(K_{L}) | K_{L}⁻¹ | S_{L} |
| Wall | K_{W} | h(K_{W}) | K_{W}⁻¹ | S_{W} |
| Inbox | K_{I} | h(K_{I}) | Sender's | K_{I} |
| | | | private key | |

Each structure uses a set of cryptographic keys. Public/private key pairs ensure the structure's integrity and are used to distribute write permissions to the users, while symmetric keys ensure the structure's confidentiality and are used to distribute read permissions to the users.

As already mentioned, each structure—Root, List, Wall and Inbox—has a public key K_{R}, K_{L}, K_{W}, K_{I} and is stored at a Cryptographically Generated Address (CGA) calculated using a hash function h( ) on the structure's public key. The CGA ensures that only the owner of a given public/private key pair is able to use the derived address. The advantages of using CGAs are twofold: i) it reduces the risk of attackers squatting chosen, unused addresses in the DHT and ii) it allows users and nodes to systematically verify the correct location of a structure. The latter advantage reduces the risk of luring users to a fake address of which an attacker has gained control.

All structures but the Inbox are self-signed using the structure's public and private key pair. In order to allow for verification of the signatures, the public key is stored in clear-text at the structure's storage address. Thus the information stored at address h(K) is the structure itself, the signed hash of the structure and the structure's public key. The Inbox is not self-signed as a whole, but each message is self-signed using the sender's private key. In order to preserve the sender's anonymity against the storing node, the sender's public key is encrypted within the sent message using the receiver's public key. The root structure is not encrypted. Thus, any user knowing the public key K_{R} or the address h(K_{R}) is able to retrieve the root structure. However, the root structure's integrity and write protection is ensured by the public/private key pair K_{R}/K_{R}⁻¹. The root's public key K_{R} is stored in clear-text at the address h(K_{R}), which allows nodes and users to verify the integrity and correct location of the root structure.

The list structure is encrypted with a (symmetric) key S_{L} (and possibly K_{L}⁻¹) and signed by the key K_{L}⁻¹. Any user having the keys S_{L} and K_{L}⁻¹ can update the list and any user possessing the key S_{L} can read the list structure. Similarly to the root structure, K_{L} is stored in clear-text at the address h(KL). The wall is encrypted with the (symmetric) key S_{W} and signed by the key K_{W}⁻¹. Anyone with knowledge of S_{W} can read the data on the wall and anyone having K_{W}⁻¹ and S_{W} can write on the wall. K_{W} is stored in clear-text at the address h(Kw). Finally, the Inbox is not integrity protected. However each stored message in the Inbox is encrypted with the public key K_{I} of the Inbox. In addition, each message is preferably signed using the private key of the sender.

As the notion of group is generic and allows many kinds of behaviour. In particular: a group can be a member of a group, a group can be a member of itself, and a principal can be a member of a group. This allows use by many kinds of applications, including but not limited to: pseudonymous groups of garners in metaverses, groups of devices in a home network, and sub-groups of devices in ad hoc networks. The present invention can thus allow rich group combinatory.

Further, as the distributed communication and data sharing system of the present invention is not tied to a specific central authority, a group can be used by more than one application, which can allow reusability.

Each feature disclosed in the description and (where appropriate) the claims and drawings may be provided independently or in any appropriate combination. Features described as being implemented in hardware may also be implemented in software, and vice versa. Reference numerals appearing in the claims are by way of illustration only and shall have no limiting effect on the scope of the claims.

1. A system for distributed communication and data sharing, the system comprising a plurality of nodes adapted to store and retrieve data, wherein the plurality of nodes are implemented on a plurality of computers, each computer of said plurality of computers being associated to at least one node, wherein each node being associated to a set of addresses comprising at least one address, a gathering of said set defining a distributed hash table wherein at least a first node of said plurality of nodes is associated to at least one first address that is obtained in function of a public key, said public key being associated to a private key, and in that a retrieve data request sent by a sending entity to a node belonging to said plurality comprises a destination address corresponding to said at least one first address, and a reply address being encrypted with said public key.

2. The system of according to claim 1 wherein the retrieve data request is signed using a private key of the sending entity and further comprises a corresponding public key.

3. The system according to claim 1, wherein the reply address is a cryptographically generated address of a public key of the sending entity.

4. The system according to claim 1, wherein the reply address is any free address of the distributed hash table.

5. The system according to claim 1, wherein said at least one first address is a cryptographically generated address with said public key.

6. The system according to claim 1, wherein said at least one first node comprises owner operation processing means that are activated after a validation of a signature of said received retrieve data request signed via said private key, said validation using said public key.
